(19) United States
(12) Patent Application Publication
(10) Pub. No.: US 2024/0262425 A1
(43) Pub. Date: Aug. 8, 2024

(54) STRUCTURAL MEMBERS FOR A VEHICLE AND METHODS

(71) Applicant: AUTOTECH ENGINEERING S.L., Amorebieta-Etxano (ES)

(72) Inventors: Sergi MARQUEZ DURAN, Rajadell (ES); Mireia ILLANA GREGORI, Barcelona (ES); Jordi HERRANZ TOMAS, Sant Boi de Llobregat (ES)

(21) Appl. No.: 18/290,197

(22) PCT Filed: May 11, 2022
(86) PCT No.: PCT/EP2022/062730

§ 371 Date: Nov. 10, 2023

(30) Foreign Application Priority Data
May 11, 2021 (EP) 21382432.9

(51) Int. Cl. B62D 21/15; B62D 29/00

(52) U.S. Cl. CPC B62D 21/152; B62D 29/007

(57) ABSTRACT

The present disclosure relates to structural members for a vehicle framework at least partially configured for supporting compressive loads. A structural member comprises a main piece and a patch. The main piece has a substantially U-shaped cross-section and comprises a bottom, a first side wall and a second side wall. The patch is attached to the main piece and comprises three patch portions: a bottom patch portion that extends over the bottom of the main piece, a first side wall patch portion that extends over the first side wall of the main piece, and a second side wall patch portion that extends over the second side wall of the main piece. The main piece is made of a more ductile material than the patch.

The present application claims the benefit of EP21382432.9 filed on May 11, 2021.

The present disclosure relates to structural members for a vehicle framework, the structural members being at least partially configured for supporting compressive loads. The present disclosure further relates to methods for manufacturing such structural members.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars.

The demand for weight reduction in the automotive industry has led to the development and implementation of lightweight materials or components, and related manufacturing processes and tools. The demand for weight reduction is especially driven by the goal of reduction of CO₂ emissions. The growing concern for occupant safety also leads to the adoption of materials which improve the integrity of the vehicle during a crash while also improving the energy absorption.

A process known as Hot Forming Die Quenching (HFDQ) uses boron steel sheets to create stamped components with Ultra High Strength Steel (UHSS) properties, with tensile strengths of e.g. 1500 MPa or 2000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction or infrared. By heating the blank, the strength of the blank is decreased and deformability increases i.e. to facilitate the hot stamping process.

There are several known Ultra High Strength steels (UHSS) for hot stamping and hardening. The blank may be made e.g. of a boron steel, coated or uncoated, such as Usibor® (22MnB5) commercially available from ArcelorMittal.

Hot Forming Die Quenching may also be called “press hardening” or “hot stamping”.

Typical vehicle components that may be manufactured using the HFDQ process include: door beams, bumper beams, cross/side members, A/B pillar reinforcements, front and rear rails, seat crossmembers and roof rails.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength. However, hot formed components offer very low levels of ductility and energy absorption in the as-formed condition.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard) and regions with increased ductility (softer), it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process, and also the use of Tailor Welded Blanks (TWB) combining different thicknesses and/or materials in blanks.

Some elements of the structural skeleton of a car e.g. front and rear rails, seat crossmembers and roof rails may be designed specifically for supporting compression loads. These and other structural members may have one or more regions with a substantially U-shaped (also known as “hat”-shaped) cross section. These structural members may be manufactured in a variety of ways and may be made of a variety of materials. Lightweight materials that improve the energy absorption during a crash while also keeping the integrity of the vehicle are desired.

In addition to the Ultra High Strength Steels mentioned before, more ductile steels may be used in parts of the structural skeleton requiring energy absorption. Examples of ductile steels include Ductibor® and CRL-340LA.

UHSS may exhibit tensile strengths as high as 1500 MPa, or even 2000 MPa or more, particularly after a press hardening operation. Once hardened, a UHSS may have a martensitic microstructure. This microstructure enables an increased maximum tensile and yield strength per weight unit.

Some ductile steels may also be heated and pressed (i.e. used in a hot stamping process), but will not have a martensitic microstructure after the process. As a result they will have lower tensile and yield strength than UHSS, but they will have a higher elongation at break.

Although ductile steel enables energy absorption by a structural member, controlling and predicting how the structural member may behave during a vehicle crash may not be easy. Also, enhancing energy absorption while maintaining a certain structural integrity of the structural member may not be straightforward.

The present disclosure aims to provide improvements in the control of the deformation of and the energy absorption by a structural member for a vehicle framework when subjected to a load, in particular a compressive load.

### SUMMARY

In a first aspect, a structural member for a vehicle framework is provided. The structural member is at least partially configured for supporting compressive loads. The structural member comprises a main piece and a patch attached to the main piece. The main piece has a substantially U-shaped cross-section and comprises a bottom, a first side wall and a second side wall. The patch comprises a bottom patch portion that extends over the bottom of the main piece, a first side wall patch portion that extends over the first side wall of the main piece, and a second side wall patch portion that extends over the second side wall of the main piece. The main piece is made of a more ductile material than the patch.

The attachment of a patch to a more ductile main piece allows combining the function of the main piece, i.e. absorbing energy during a crash, while reinforcing the main piece and controlling the kinematics of deformation. As a patch that is less ductile than the main piece may crack when the structural member is subjected to a compressive load, cracks in the patch may enable the absorption of more energy during the compression.

For instance, a front rail in a car comprising a patch that is stronger and less ductile than the remainder of the front rail will be deformed in a different way during a car collision than if e.g. the patch is absent or if the patch is made of the same material as the main piece. Attaching one or more patches which are less ductile than the main piece to the main piece may enable the control and tailoring of the deformation of the structural member. The energy absorption during the collapse of the structural member may also controlled and deformation predictability may be increased. Thus, safety for a vehicle passenger may be enhanced.

In general, this configuration of a ductile main piece and less ductile patch has been found to be particularly advantageous for structural members supporting compressive loads. A compressive load may be understood as a load or a component of a load acting substantially parallel to a length of the structural member in such a way as to attempt to shorten the component. Components or regions in frameworks of cars that may be particularly subjected to compressive loads include: front rails, rear rails, energy absorbers, roof rails and seat crossmembers. Therefore, the examples disclosed herein may be especially beneficial when used in this type of components.

Throughout the present disclosure, “at least partially configured for supporting compressive loads” may be understood as meaning that a part of a component, or the entire component is expected to absorb mainly compressive loads in case of an impact or crash. I.e. even though other loads may occur as well, the compressive loads are expected to be higher.

In some examples, the patch may be made of hardened, specifically press hardened steel. The patch may be made of ultra high strength steel (UHSS) with ultimate tensile strength of 1000 MPa or more. In some examples, the patch may be made of a non-press hardened martensitic steel.

In some examples, the patch may be positioned in an interior side of the main piece. Herein, an interior of the main piece may be understood as the side of the main piece which has a concave angle, e.g. of less than 180°, optionally about 90°, between the first side wall or the second side and the bottom of the main piece.

As the patch may be made of hardened steel, e.g. Usibor® or 22MnB5, the patch may crack in some areas during a crash. Although the ductility of the main piece can keep the energy absorption function of the structural member irrespective of the patch being in an interior or an exterior side of the main piece as long as they stay attached, it may be advantageous to position the patch in an interior of the main piece in order to protect any piece near the structural member from possible damage coming from the deformation and/or breaking of the patch.

In some examples, a height of the first and/or second side wall patch portion may vary in a longitudinal direction of the structural member.

In some examples, a height of at least one of the first and the second side wall patch portions may increase along a longitudinal direction from a side of the structural piece configured to receive a compression impact.

A height of a side wall patch portion may be measured in a direction substantially perpendicular to a longitudinal direction of the main piece from a longitudinal edge of the main piece at which the side wall patch portion begins to extend over the side wall of the main piece.

By including sections of the structural member that are weaker than others, a location along the longitudinal direction of the main piece where deformation may start may be controlled. In particular, as a side wall patch portion may extend more over a side wall at a first cross-section closer to a longitudinal side configured to receive an impact than over the side wall at a second cross-section which is farther away from the side configured to receive an impact, the main piece may start to deform at the first cross-section. In general, by varying a height of a side wall patch portion along a length of the main piece may help to adjust which portions of the main piece bend and if they do it before or after other portions.

A side configured to receive an impact may be a longitudinal end of the structural member or of the main piece which may be oriented such that it is closer to where a possible compressive hit may be received.

Also, the amount of energy absorption along a length of the main piece may be tailored. More energy may be absorbed when a height of a side wall patch portion is larger.

Therefore, energy absorption may increase from a first cross-section of the main piece closer to where an impact may be received to a cross-section which is farther away.

In some examples, the patch may comprise one or more ribs extending at least over one of the first side wall and the second side wall. For instance, the patch may have one or more ribs in the first side wall patch portion, or one or more ribs in the second side wall patch portion, or one or more ribs in the first side wall patch portion and one or more ribs in the second side wall patch portion. The ribs may be separated along a length of the main piece by recesses or cut-outs.

Throughout this disclosure a rib may be understood as an elongated, substantially straight part of a patch for local reinforcement.

The presence of one or more ribs in the patch may help to adjust the deformation behavior of the structural member. The ribs, which are less ductile and more resistant than the main piece, may help to create specific bending locations in the structural member. Specifically, the recesses between the ribs may be determinant of where bending may occur in the main piece. The geometry, size and position of the ribs may facilitate tailoring of not only where bending occurs in the structural member, but also e.g. the extent to which the structural member is deformed. Accordingly, the deformation of the structural member can be optimized. Particularly when the structural member is configured to support compressive loads, the energy absorption can be increased.

In some examples, a height of the recesses in a side wall may decrease along a longitudinal direction from a side of the structural piece configured to receive an impact. The height of a recesses may be measured along a direction substantially perpendicular to a length of the main piece.

Therefore, deformation of the main piece may start in a recess having the biggest height, for example the recess closest to a longitudinal side of the main piece which is closest to where an impact may be received. Varying the heights of the recesses between the ribs may enable controlling which portions of the main piece may bend before than other portions of the main piece.

In specific examples, a structural member for a vehicle framework at least partially configured for supporting compressive loads is provided. A length of the structural member may extend between an impact receiving end and an opposite end. The structural member comprises a main piece with a substantially U-shaped cross-section comprising a bottom, a first side wall and a second side wall and a patch attached to the main piece. The patch extends from a patch front end to a patch rear end, wherein the patch front end is arranged closer to the impact receiving end of the structural member than the patch rear end. The patch comprises a bottom patch portion that extends over the bottom of the main piece, a first side wall patch portion that extends over the first side wall of the main piece and a second side wall patch portion that extends over the second side wall of the main piece. The main piece is made of a more ductile material than the patch and the structural member is configured to deform in a crash such that a plurality of folds occurs between the patch front end and the patch rear end. The folds may have a generally increasing buckling resistance from the patch front end to the patch rear end.

Within the scope of the present disclosure, a patch may incorporate any number of ribs per side wall patch portion positioned at any location along a length of the main piece in order to obtain a specific deformation behavior of the structural member. Some possible configurations are the following:

In some examples, the first side wall patch portion may comprise one or more ribs, the second side wall patch portion may comprise one or more ribs, and one or more ribs in the first side wall patch portion may face one or more ribs in the second side wall patch portion.

In some of these examples, there may be the same number of ribs in the first side wall patch portion and in the second side wall patch portion, and each of the ribs in the first side wall patch portion may face a corresponding opposite rib in the second side wall patch portion.

In some examples, the first side wall patch portion may comprise one or more ribs, the second side wall patch portion may comprise one or more ribs, and one or more ribs in the first side wall patch portion may be offset from one or more corresponding opposite ribs in the second side wall patch portion along a longitudinal direction of the main piece.

In some of these examples the first side wall patch portion may comprise one or more ribs, the second side wall patch portion may comprise one or more ribs, and each of the one or more ribs in the first side wall patch portion may be offset from each of the one or more corresponding opposite ribs in the second side wall patch portion along a longitudinal direction of the main piece, such that each of the ribs in the first side wall patch portion may face a space between and/or around a corresponding opposite rib in the second side wall patch portion.

In general, the more a patch extends over the first and second side walls of the main piece is, the greater the reinforcement may be and the higher and finer the control of the deformation of the structural member may become. Therefore, in some examples, the first side wall patch portion may extend over the first side wall at least 25% of a height of the first wall and the second side wall patch portion may extend over the second side wall at least 25% of a height of the second side wall.

The number, position and extension of patches attached to the main piece, as well as the number, position and extension of ribs in a patch may be selected according to a desired behavior of the structural member in terms of deformation, e.g. particularly under compressive loads of the main piece resulting from a (simulated) impact or crash. For instance, the number, size and position of attachment of the patches may be selected in order to meet certain design requirements of the structural member.

In a further aspect, a method for manufacturing a structural member at least partially configured for supporting compressive loads in order to obtain a structural member for a vehicle framework as described in this disclosure is provided.

The method comprises providing a main piece blank and providing a patch blank. The method further comprises attaching the patch blank to the main piece blank to form a patchwork blank, and forming the patchwork blank to obtain a structural member as disclosed herein.

This method may improve the deformation behavior of a structural member configured for supporting compressive loads and may enable adjusting how the structural member deforms during e.g. a car crash. Thus, energy absorption by the structural member may be enhanced.

A main piece blank is to be understood herein as a blank, e.g. a metal sheet or flat metal plate that will form the main piece. A patch blank is to be understood herein as a blank that will form the patch.

In some examples, the method may include hot forming, e.g. direct hot stamping. In some other examples, the method may include cold forming, e.g. stamping in a press at ambient temperature or relatively low temperatures. In this case, after deformation the structural member may undergo a heat treatment involving e.g. austenization to provide the materials with a desired microstructure and mechanical properties.

In some examples, the patch may be attached to the main piece by spot welding. Spot welding joins the main piece and the patch in specific areas, causing the deformation of the structural member to change depending on e.g. the location of the spot welds and the distance among them. Hence, spot welding may help to manufacture a structural member with a specific attachment pattern between the main piece and a patch which causes the structural member to deform in a particular manner whereas the ductility of the main piece may confer an overall ductility to the structural member.

In some other examples, at least a rib may be attached to the main piece by continuous (remote) laser welding. Spot welding may not be an appropriate method to attach one or more ribs in the patch blank to the main blank due to the relatively small size of the ribs as spot welding may require e.g. a minimum distance between the spot welds and/or a minimum spot weld overlap region. Using continuous laser welding to attach one or more ribs of the patch blank to the main piece may overcome these and other limitations of spot welding. Continuous laser welding may also improve the strength of the attachment as well as enable the patch and the main piece to work together in a greater degree than spot welding does.

In some examples, all the ribs may be attached by continuous laser welding. The use of continuous laser welding is not limited to the ribs in the patch, i.e., it may be used as an attachment method wherever in the patch as deemed necessary.

### BRIEF DESCRIPTION OF THE DRAWINGS

Non-limiting examples of the present disclosure will be described in the following, with reference to the appended figures, in which:

FIG. 1A schematically represents an example of a structural member for a vehicle at least partially configured for supporting compressive loads.

FIG. 1B schematically illustrates how a patch and a main piece of a structural member may be joined.

FIGS. 2A to 2C schematically illustrate examples of structural members with different patch shapes.

FIG. 2D schematically illustrates three cross-sections of the structural member of FIG. 2C.

FIG. 3A schematically illustrates a structural member for a vehicle at least partially configured for supporting compressive loads with still a different shape of the patch.

FIGS. 3B to 3E schematically illustrate four examples of rib configurations of a patch attached to a main piece of a structural member for a vehicle at least partially configured for supporting compressive loads.

FIGS. 4A and 4B schematically illustrate two further examples of structural members with different rib configurations.

FIG. 5 is a flow chart of a method for manufacturing a structural member at least partially configured for supporting compressive loads.

The figures refer to example implementations and are only be used as an aid for understanding the claimed subject matter, not for limiting it in any sense.

### DETAILED DESCRIPTION OF EXAMPLES

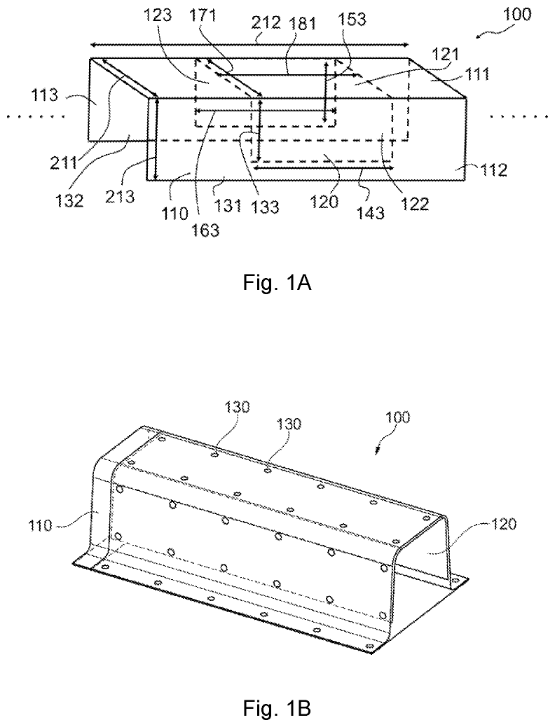

FIG. 1A schematically represents a structural member 100 for a vehicle configured, or at least partially configured, for supporting compressive loads. A structural member 100 comprises a main piece 110 with a substantially U-shaped cross-section comprising a bottom 111, a first side wall 112 and a second side wall 113.

The structural member 100 further comprises a patch 120 attached to the main piece 110. The patch 120 comprises a bottom patch portion 121 that extends over the bottom 111 of the main piece 110, a first side wall patch portion 122 that extends over the first side wall 112 of the main piece 110 and a second side wall patch portion 123 that extends over the second side wall 113 of the main piece 110.

The main piece 110 is made of a more ductile material than the patch. For example, the patch may be made of hardened steel, and the main piece may be made of a more ductile material than hardened steel.

As the patch 120 may crack when the structural member 100 is submitted to a compressive load, energy absorption by the structural member 100 may be enhanced. Control of the deformation of the main piece 110 and the structural member 100 may be further increased by attaching more than one patch 120 to the main piece 110 (not shown in FIG. 1).

The dots in FIG. 1A indicate that the structural member 100 may comprise or be attached to one or more additional pieces or elements of a structural framework not shown. These one or more additional pieces or elements are not limited in any way, e.g., in shape, size, shape of cross-section, material and/or how they are attached to the main piece 110.

In this figure, and in other figures, the main piece 110 is shown to be “hat-shaped” or to have a “U-shaped” cross-section. It should be clear that in all these examples, the main piece may include side flanges extending outwardly from the side walls 112, 113.

Although depicted as substantially straight, the bottom 111, the first side wall 112 and the second side wall 113 of the main piece 110 are not necessarily straight. For instance, the bottom 111 may be curved or comprise recess or protrusions along the bottom. This also applies to the side walls 112, 113, which are not necessarily straight.

The side walls may include straight portions with a transition zone between straight portions. In addition, side walls 112, 113 may or may not be symmetrical. For example, a height 213 of the first side wall 112 may be different from a height 153 of the second side wall 113. For instance, a height along the length 212 of the first 112 and/or second 113 walls may also vary. For example, the width 211 of the bottom 111 may be different from the 213 height of the first 112 and/or second 113 side walls. Other examples may include any combination of the above examples. The only limitation is that the person skilled in the art recognizes the main piece 110 as having a substantially U-shaped cross-section.

In some examples, the patch 120 may be made of a boron steel like Usibor®, e.g. Usibor® 1500, or of 22MnB5, or any martensitic steel or ultra high strength steel (UHSS). In these or other examples, the main piece 110 may be made of Ductibor®, e.g. Ductibor® 400, or of CRL-340LA, in particular any steel that may be hot stamped but has relatively ductile properties after a stamping process. Usibor®, Ductibor® and 22MnB5 may be commercially available from ArcelorMittal. CRL-340LA is commercially available from SSAB. In some examples, the main piece 110 may have an ultimate tensile strength below 1000 MPa and the patch 120 may have an ultimate tensile strength above 1000 MPa.

Usibor® 1500 is supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and unavoidable impurities):

| C | Si | Mn | P | S | Cr | Ti | B | N |
|---|---|---|---|---|---|---|---|---|
| 0.24 | 0.27 | 1.14 | 0.015 | 0.001 | 0.17 | 0.036 | 0.003 | 0.004 |

Usibor® 2000 is another boron steel with even higher strength. After a hot stamping die quenching process, the yield strength of Usibor® 2000 may be 1400 MPa or more, and its ultimate tensile strength may be above 1800 MPa. A composition of Usibor® 2000 includes a maximum of 0.37% of carbon, a maximum of manganese of 1.4%, a maximum of 0.7% of silicon and a maximum of 0.005% of boron by weight.

22MnB5 may be presented with an aluminum-silicon coating in order to avoid decarburization and scale formation during the forming process. A composition of 22MnB5 is summarized below in weight percentages (the rest is iron (Fe) and impurities):

| | |
|---|---|
| C | 0.20-0.25 |
| Si | 0.15-1.35 |
| Mn | 1.10-1.25 |
| P | <0.025 |
| S | <0.008 |
| Cr | 0.15-0.30 |
| Ti | 0.02-0.05 |
| B | 0.002-0.004 |
| N | <0.009 |

Several 22MnB5 steels are commercially available having a similar chemical composition. However, the exact amount of each of the components in a 22MnB5 steel may vary slightly from one manufacturer to another. Other ultra high strength steels include e.g. BTR 165, commercially available from Benteler.

Ductibor® 450 may have an ultimate tensile strength of 460 MPa or more, Ductibor® 500 of 550 MPa or more, and Ductibor® 1000 of 1000 MPa or more.

CRL-340LA is a steel that is commercially available from SSAB. It is a high-strength low-alloy steel intended for general presswork, bending and forming. Its composition is outlined in the following (weight percentages).

| | |
|---|---|
| C max | 0.1% |
| Si max | 0.040% |
| Mn max | 1% |
| P max | 0.030% |
| S max | 0.025% |
| Al min | 0.015%) |
| Nb + Ti max | 0.1% |

The main piece 110 has two sides: an exterior side 131 and an interior side 132.

In some examples, the patch 120 is positioned at an interior side of the main piece 110, as in FIG. 1A. In some other examples, the patch may be positioned in an exterior side of the main piece 110.

As the patch 120 may crack when the structural member 100 is submitted to a compressive load, it may be advantageous to attach the patch 120 to an interior 132 of the main piece 110 for reducing or avoiding the risk of damage of one or more vehicle components near the structural member 100 during a crash.

A patch 120 may be welded to the main piece 110, e.g. before introducing the patchwork in a furnace or a press. In this regard, the assembly of one or more patches 120 attached to a main piece 110, e.g. by spot welding, may be referred to as patchwork. A patchwork is thus different from a tailor welded blank, in which blanks are joined to each other through edge-to-edge welding.

As illustrated in FIG. 1B by spot welds 130, the patch 120 and the main piece 110 may be joined by spot welding in some examples. This applies to any number of patches that may be attached to the main piece 110. Having more than one patch attached to the main piece may enhance versatility, efficiency and optimization of the structural member.

The patch 120 may extend along the whole length 212 of the main piece 110 in some examples. A larger patch may enable a better control of the deformation of the main piece 110.

This also applies to the extension that a patch 120 may cover in a direction substantially parallel to a height 213 of the main piece 110. In some examples, as e.g. in FIGS. 1A and 1B, the first side wall patch portion 122 extends over the first side wall 112 at least 25%, optionally at least 50%, optionally at least 75%, of a height 213 of the first wall 112 and the second side wall patch portion 123 extends over the second side wall 113 at least 25%, optionally at least 50%, optionally at least 75%, of a height 213 of the second side wall 113.

A bottom patch portion 121 in this example has a width 171 and a length 181. A first side wall patch portion 122 in this example has a height 133 and a length 143. And a second side wall patch portion 123 in this example has a height 153 and a length 163. A width 171 of the bottom patch portion may be measured in a direction substantially perpendicular to a length 212 or longitudinal direction of the main piece. A height 133, 153 of the side wall patch portions 122, 123 may be measured in a direction substantially perpendicular to a length 212 of the main piece 110. A length of the bottom patch portion 121 and of the side wall patch portions 122, 123 may be measured in a direction substantially parallel to a length 212 of the main piece 110.

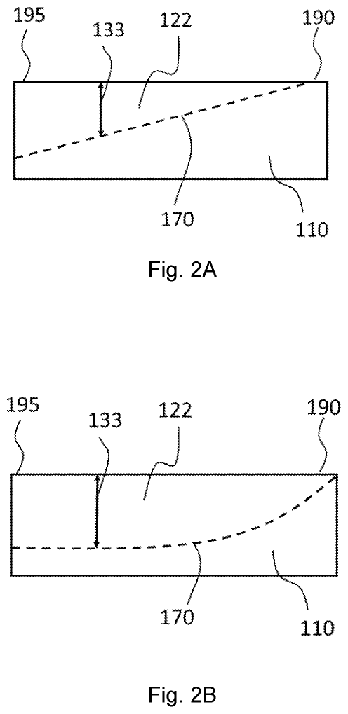

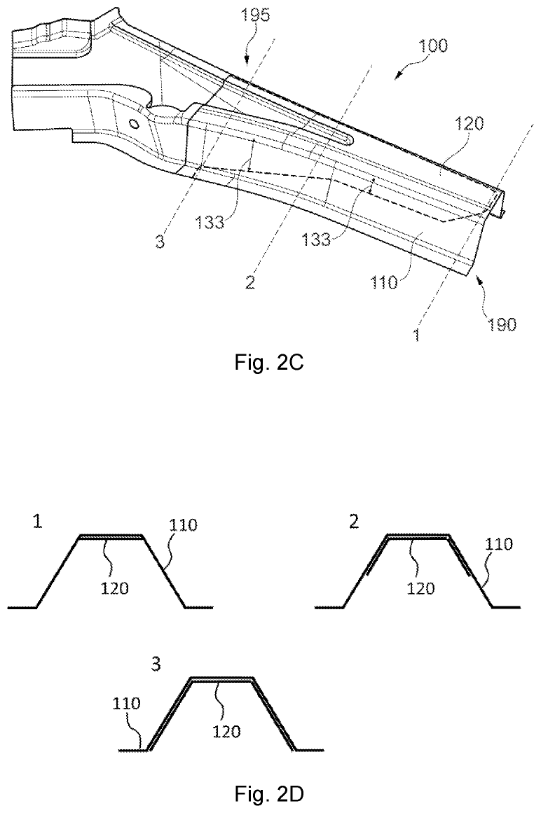

A height 133, 153 of a side wall patch portion 122, 123 may vary along a length 143, 163 of the side wall patch portion, and therefore also along a length 212 of the main piece 110. FIGS. 2A and 2B schematically show a side view of a main piece 110 with a side wall patch portion having a varying height 133.

In some examples, a height 133, 153 of at last a side wall patch portion 122, 123 may increase when moving away from a side of the structural piece configured to receive a compression impact 190. Such a longitudinal end 190 of the structural member, or of the main piece, may be herein referred to as “front end”. A patch 120 may likewise have a longitudinal “front end” and an opposite “rear end”, the front end of the patch being closer to the impact receiving end of the structural member 100 or the main piece 110 than the opposite rear end of the patch 120.

In FIGS. 2A and 2B, a compression impact may be received in the main piece 110 at the right side. For example, for a front rail, the right side of the figure would be the front side of the front rail. For a rear rail, the right side of the figure would be the rear side of the rear rail.

Therefore, deformation of the main piece 110 may start close to where the impact takes place instead of in any other region. A plurality of folds may form between a patch front end and a patch rear end in the case of an impact (crash). As a height of at least a side wall patch portion 122, 123 increases towards a rear end of the patch 120, a buckling resistance of the folds may increase from the patch front end to the patch rear end. I.e., a resistance to a sudden change of shape of the structural member under a compressive load may increase towards the patch rear end. In FIG. 2A, a height 133 of a side wall patch portion increases linearly along a length of the patch. In FIG. 2B, a height 133 of a side wall patch portion increases non-linearly.

Varying the height of one or both the side wall patch portions may facilitate controlling the deformation of the main piece 110, and in particular where the deformation begins. The curvature followed by the outward edge 170 delimiting a height of a side wall patch portion enables adjusting the force at which the main piece 110 and the structural member 100 deform under a compressive load. The curvature may also enable adjusting the amount of energy absorbed along a length of the main piece 110.

FIG. 2C illustrates a perspective view of a structural member 100. In this example, the structural member is a front rail for a vehicle. A patch 120 which extends along a whole length 212 of the main piece 110 is provided in an inside of the main piece 110.

In this example, similarly to FIGS. 2A and 2B, a height of a side wall patch portion increases towards an end 195 of the main piece 110 which is expected to be subjected to a compression load later than the front end 190. Such end 195 may be herein referred to as “rear end”. In FIG. 2C, starting at the front end 190, a height of a side wall patch portion increases linearly, to then remain constant, and to later on keep increasing linearly. At the rear end 195 of the main piece, the side wall patch portion has its biggest height.

Also in the case of FIG. 2C, the buckling resistance increases from the end where a crash load is expected to the opposite end. Consecutive folds will thus generally have an increased resistance to buckling.

FIG. 2D schematically illustrates three cross-sections of the main piece 100 and patch 120 of FIG. 2C. The first cross-section, which is a cross-section close to the front end 190, shows how the bottom portion of the patch does not necessarily need to cover the entire bottom of the main piece 110. That is to say, in cross-section, a bottom portion of the patch may not need to extend 171 along a whole width 211 of the main piece.

In particular, a width of the bottom portion 171 may taper towards the front end 190. This may help to ensure that the structural member begins to deform at the front end 190 or close to it.

Cross-section 2 shows that a whole width 211 of the main piece is covered by the bottom portion of the patch, and also that a height 133, 153 of both side wall patch portions has increased towards the read end 195. A height of both side wall patch portions has further increased in cross-section 3.

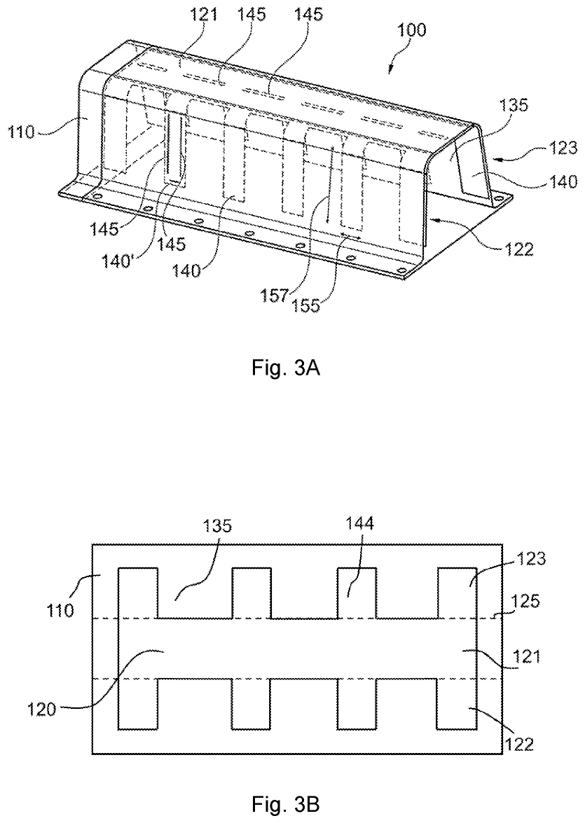

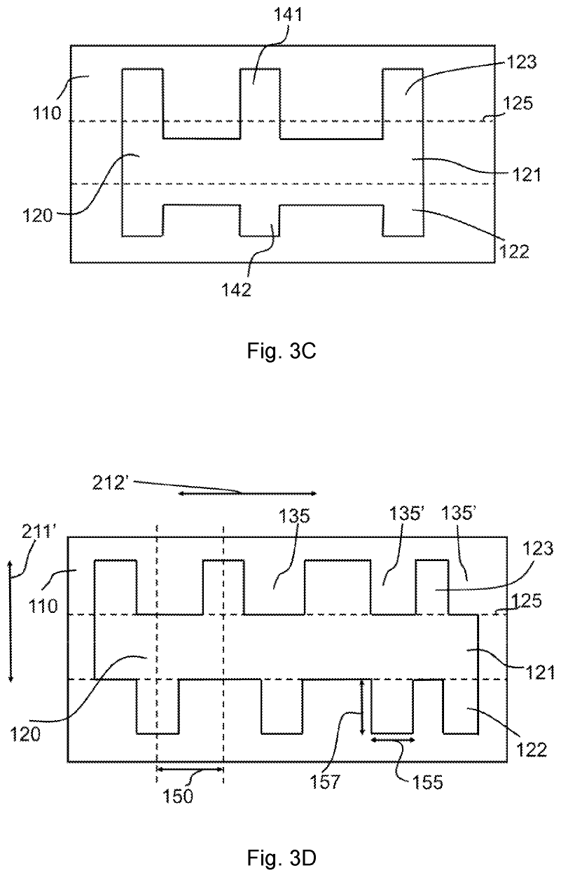

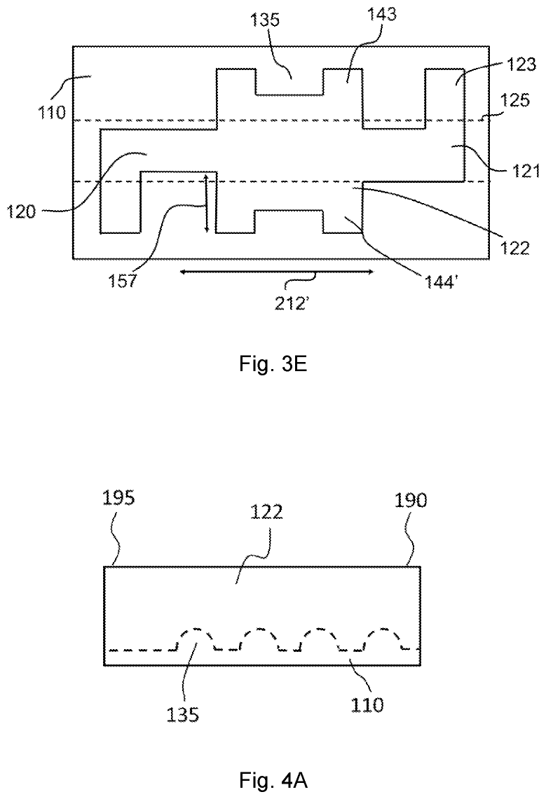

In some examples, the patch 120 may have cut-outs 135 in the first 122 and/or second 123 side wall patch portions such that ribs 140 are formed in the patch 120, as shown in FIG. 3A. In these examples, the patch 120 may comprise one or more ribs 140 extending at least over one of the first side wall patch portion 122 and the second side wall patch portion 123. In the particular example of FIG. 3A, both the first 121 and second 122 side wall patch portions include ribs 140.

Features of the ribs 140 including its number, shape, size, location in the patch 120 and extension over the main piece 110 may be tailored to adjust the behavior of the structural member 100 when subjected to a compression load. The ribs create harder and stiffer areas in the structural member 100. Thus, when the structural member 100 is subjected to a compression load, it may bend between the ribs 140 creating folds. This way, the behavior of the main piece 110 and the structural member 100 may be better controlled in a collision. Likewise, the kinematics, e.g. the speed at which the structural member 100 deforms, may be adjusted too.

It is noted that the spot welds 130 may have a similar function to the ribs 140 as in FIG. 1B. The spot welds 130 may not only serve as attaching means, but also serve to determine points where the structural member 100 may bend under a compression load.

In addition, as the patch 120 may crack as explained above, energy absorption by the structural member 100 may increase. This applies to both the examples of patches 120 with and without ribs 140.

Accordingly, safety of the passengers in a vehicle including one or more structural members 100 as described herein may be enhanced too.

The ribs 140 of a patch 120 may be welded to the main piece 110. In some examples, one or more ribs 140 may be joined to the main piece 120 by remote laser welding. A rib 140′ is attached to the main piece 110 by continuous remote laser welding along an edge of the rib 140′ in FIG. 3A. Although three welds 145 may be seen in FIG. 3A, more or less welds 145 may be used in other examples. For instance, a single continuous weld 145 may be performed to attach a rib 140 to the main piece 110.

Attaching the ribs 140 by continuous welding 145 instead of spot welding 130 may increase the strength of the attachment. Continuous laser welding may also help to keep the patch 120 and the main piece 110 well joined when placing a patchwork blank in a furnace to heat it previous to press stamping it.

Any of spot welding or remote laser welding may be used to join the bottom patch portion 121 to the main piece 110. Continuous laser welds 145 may be seen in FIG. 3A, but spot welding could also be used. Likewise, continuous laser welding may have been used as attachment means in the example of FIG. 1B in addition or alternatively to spot welding.

Ribs 140 may be arranged in several ways and may have different features. Some possibilities are depicted in FIGS. 3B-3E. These figures schematically illustrate an unfolded structural member 100, e.g. as if a patchwork blank comprising a main piece blank and a patch blank has not been press hardened or cold formed yet.

The structural member 100 of FIG. 3B may correspond to the structural member of FIG. 3A, but with four ribs 140 per patch wall side instead of six.

In some examples, as illustrated in FIGS. 3A, 3B and 3C and 3E, the first side wall patch portion 122 may comprise one or more ribs 140, the second side wall patch portion 123 may comprise one or more ribs 140, and one or more ribs 140 in the first side wall patch portion 122 may face one or more ribs 140 in the second side wall patch portion 123.

As it may be seen in FIGS. 3C and 3E, a rib 141 may protrude from a bottom patch portion 121, a rib 142 may protrude from a side wall patch portion 122, 123 and a rib 143 may protrude from both a bottom 121 and side wall patch portion 122, 123. A rib 144 may also protrude entirely, as in FIG. 3B, or partially 144′, as in FIG. 3E, from a patch junction 125 separating a side wall 122, 123 and bottom 121 patch portions.

Thus, one or more ribs may extend over a side wall patch portion 122, 123 and also further extend over the bottom patch portion 121, see for example rib 141 in FIG. 3C and ribs 143 and 144′ in FIG. 3E.

In some examples, there may be the same number of ribs 140 in the first side wall patch portion 122 and in the second side wall patch portion 123, and each of the ribs 140 in the first side wall patch portion 122 may face a corresponding opposite rib 140 in the second side wall patch portion 123, as e.g. in FIGS. 3A, 3B and 3C.

In some other examples, as in FIG. 3D, the first side wall patch portion 122 may comprise one or more ribs 140, the second side wall patch portion 123 may comprise one or more ribs 140, and one or more ribs 140 in the first side wall patch portion 122 may be offset 150 from one or more corresponding opposite ribs 140 in the second side wall patch portion 123 along a longitudinal direction 212′ of the main piece 110.

Although ribs 140 in FIGS. 3A and 3B-3E may have a substantially rectangular shape, other shapes are possible. The rib edges may not need to be straight and a rib width 155 may not need to be constant along a height 157 of the rib as depicted in these figures either. In the case that a rib 140, e.g. any of ribs 143, 144′, has edges starting to protrude at different points, a rib height 157 may be considered a longitudinal distance concerning the longest rib edge, see FIG. 3E.

In some examples, as e.g. in FIG. 3D, there is the same number of ribs 140 in the first side wall patch portion 122 and in the second side wall patch portion 123, and all the ribs 140 in the first side wall patch portion 122 are offset 150 from the corresponding opposite ribs 140 in the second side wall patch portion 123 along a longitudinal direction 212′ of the main piece 110 such that the ribs 140 in the first 122 or second 123 side wall patch portion face a space 135′ between and/or around the ribs 140 in the other side wall patch portion 123, 122.

In some examples, as e.g. in FIG. 3A, a height 157 of at least one rib 140 may be bigger than a width 155 of the corresponding rib 140, the height 157 of a rib 140 being measured along a transversal direction 211′ of the main piece 110 and the width 155 of a rib 140 being measured along a longitudinal direction 212′ of the main piece 110. As explained above with regard to the extension of the patch 120 over the main piece 110, and in particular over the side wall patch portions 122, 123, this may increase deformation control of the structural member 110.

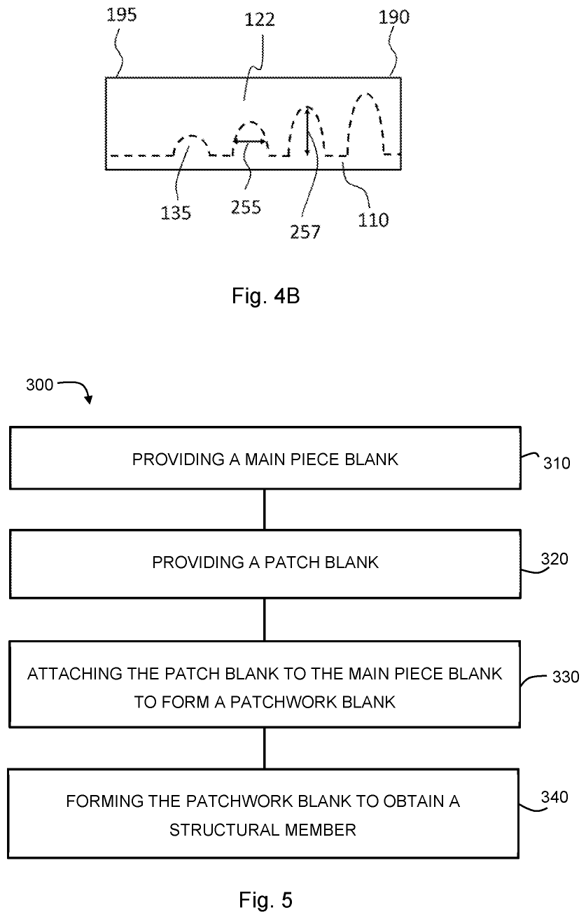

FIGS. 4A and 4B schematically represent side views of a main piece 110 with a patch 120 attached to the main piece 110. In these figures, the recesses 135 separating the ribs 140 have a rounded or half-oval shape. A recess 135 may have a height 257 and a width 255. A height 257 may be measured in a direction substantially perpendicular to a length 212 of the main piece 110. A width 255 may vary along a height 257 of a cut-out 135.

In some examples, a height 257 of the recesses 135 in a side wall patch portion may decrease in a longitudinal direction from a side of the structural piece 100 configured to receive an impact. FIG. 4B illustrates such an example. In this figure, if an impact is received from right to left, the portion of the main piece 110 overlapping with the recess which is closest to where the impact may be received, may bend first and create a first fold. Then, the structural member may bend where the next highest recess is and create a second fold, and so on. The deformation may thus include multiple folds and be like a concertina or accordion. The folds may have a generally increasing buckling resistance from the patch front end to the patch rear end, because of the reducing depth of the recesses in that direction.

In FIG. 4A, the structural member may bend where the recesses 135 are located. Kinematics and energy absorption during deformation may be controlled.

In another aspect of the invention, a method 300 for manufacturing a structural member 100 at least partially configured for supporting compressive as described throughout this disclosure, is provided. The order of the different steps or stages of the method 300 should not be interpreted as limiting.

The method comprises, at block 310, providing a main piece blank.

The method further comprises, at block 320, providing a patch blank.

The main piece blank and the patch blank may have same or different sizes and shapes.

For instance, in some examples, the main piece blank and the patch blank may be both rectangular, and the patch blank may have a length and a width substantially equal to a length and shorter than a width of the main piece blank made. When attaching these blanks and forming them, e.g. by heating them in a furnace and press-hardening them, one may obtain a structural member such as in FIG. 1B.

In some other examples, the patch blank may have one or more ribs 140. In these examples, providing a patch blank may include performing some cut-outs 135 to create the one or more ribs 140. The deformation of a structural member 100 under compression may be better adjusted with the use of ribs 140.

Size, shape and number of ribs 140 may be selected according to a desired behavior of the structural member 100 when subjected to a compressive load. The position of the patch blank with respect to the main piece blank may also be selected accordingly.

In some examples, the patch blank is made of hardenable steel, such as Usibor® 2000, and the main piece blank is made of a steel more ductile than the hardenable steel, e.g. Ductibor® 1000.

In general, the main blank and the at least first patch blank may be substantially planar when they are to be joined to each other.

The method further comprises, at block 330, attaching the patch blank to the main piece blank to form a patchwork blank. Welding may be used for attachment. In some examples, spot welding and/or remote laser welding may be used to attach any of the blank regions to be later on the bottom patch portion 121 and the first 122 and second 123 side wall patch portions to the main piece blank.

In some examples, spot welding 130 may be used as the only welding process for attaching the blanks, e.g. as in the example of FIG. 1B. In some other examples, continuous laser welding 145 may be used as an alternative or in addition to spot welding. For example, remote laser welding may be used to attach one or more ribs 140, optionally all the ribs 140, to the main blank piece, as in the example of FIG. 3A.

Spot and/or continuous laser welding may help tailor the deformation in the main piece 110 and the structural member 100 during a crash. Continuous laser welding may cause the patchwork to work as a single entity instead of as two separate pieces. Attachment strength and subsequent behavior of the structural member 100 when subjected to compression may be thus improved.

The method further comprises, at block 340, deforming the patchwork blank to obtain a structural member as described herein.

Forming confers a desired shape to the patchwork. Due to forming, the obtained structural member 100 includes a main piece 110 with a substantially U-shaped cross section.

Forming may include any kind of forming, such as hot forming, e.g. direct or indirect hot stamping, or cold forming. Forming may not only shape the patchwork, but forming may also provide additional properties, such as an increase of strength of the patchwork as e.g. in hot forming due to the change of microstructure of the steel.

Hot forming, e.g. direct hot stamping, may include heating the patchwork blank above an austenization temperature, specifically above Ac3, for a minimum period of time, e.g. for a few minutes. Heating may be performed in a furnace. The patchwork blank may then be transferred to a press in which the blank shape is changed to form a component and at the same time is rapidly cooled (“quenched”) to below 400° C., or specifically below 300° C.

If a hardenable steel is used for the patch and a softer steel is used for the main piece, the patch will have a high ultimate tensile strength, but by itself will be relatively brittle and allow for little elongation before break. The main piece on the other hand will be more ductile, allowing for more elongation before break.

Cold forming may include introducing the patchwork in a press in order to shape it. In a cold forming process, a martensitic steel such as e.g. MS1200 may be used for the patch which retains a martensitic microstructure even without heating to an austenization temperature.

Alternatively a manganese press hardenable boron steel as 22MnB5 may be used in a cold forming process. After forming, the resulting component may be heated and sufficiently rapidly cooled to obtain a desired microstructure.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A structural member for a vehicle framework at least partially configured for supporting compressive loads and having a length between an impact receiving end and an opposite end comprising:
a main piece with a substantially U-shaped cross-section comprising a bottom, a first side wall and a second side wall; and
a patch attached to the main piece, the patch extending from a patch front end to a patch rear end, wherein the patch front end is arranged closer to the impact receiving end of the structural member than the patch rear end;
the patch comprising a bottom patch portion that extends over the bottom of the main piece, a first side wall patch portion that extends over the first side wall of the main piece and a second side wall patch portion that extends over the second side wall of the main piece;
wherein the main piece is made of a more ductile material than the patch; and
wherein the structural member is configured to deform in a crash such that a plurality of folds occurs between the patch front end and the patch rear end; and
wherein the folds have a generally increasing buckling resistance from the patch front end to the patch rear end.

2. The structural member of claim 1, wherein the patch is positioned in an interior of the main piece.

3. The structural member of claim 1, wherein a height of at least one of the first and second side wall patch portions increases from the impact receiving end of the structural member to the opposite end.

4. The structural member of claim 1, wherein at least one of the first side wall patch portion and/or the second side wall patch portion comprises one or more ribs separated by recesses along a length of the main piece.

5. The structural member of claim 4, wherein a height of the recesses in the first and/or second side wall patch portions decreases along a longitudinal direction form the impact receiving end of the structural member.

6. The structural member of claim 4, wherein the first side wall patch portion comprises one or more first ribs, the second side wall patch portion comprises one or more second ribs, and one or more of the first ribs of the first side wall patch portion face one or more of the second ribs of the second side wall patch portion.

7. The structural member of claim 4, wherein the first side wall patch portion comprises one or more first ribs, the second side wall patch portion comprises one or more second ribs, and wherein the first ribs of the first side wall patch portion are offset along a longitudinal direction of the main piece with respect to the second ribs of the second side wall patch portion.

8. The structural member of claim 4, wherein a height of at least one rib measured along a height of a sidewall of the main piece is larger than a width of the rib being measured along a longitudinal direction of the main piece.

9. The structural member of claim 1, wherein the patch is made of a press hardened ultra high strength steel.

10. The structural member of claim 1, wherein the structural member is or forms part of a front rail, a crash box, or an inner rocker reinforcement.

11. A method for manufacturing a structural member at least partially configured for supporting compressive loads comprising a main piece with a substantially U-shaped cross-section including a bottom, a first side wall and a second side wall; and
a patch attached to the main piece, the patch extending from a patch front end to a patch rear end, wherein the patch front end is arranged closer to an impact receiving end of the structural member than the patch rear end;
the patch comprising a bottom patch portion that extends over the bottom of the main piece, a first side wall patch portion that extends over the first side wall of the main piece and a second side wall patch portion that extends over the second side wall of the main piece;
wherein the main piece is made of a more ductile material than the patch; and
wherein the structural member is configured to deform in a crash such that a plurality of folds occurs between the patch front end and the patch rear end; and
wherein the folds have a generally increasing buckling resistance from the patch front end to the patch rear end, the method comprising:
providing a patch blank configured to form the patch;
providing a main piece blank configured to form the main piece;
attaching the patch blank to the main blank to form a patchwork blank; and
forming the patchwork blank to obtain the structural member.

12. The method of claim 11, wherein the patch blank is made of hardenable steel and the main blank is made of a more ductile material steel than the hardenable steel.

13. The method of claim 11, wherein forming includes cold forming.

14. The method of claim 11, wherein the patch is attached to the main piece by spot welding.

15. (canceled)

16. The structural member of claim 4, wherein the first side wall patch portion comprises one or more first ribs separated by recesses along a length of the main piece, and wherein the first ribs are arranged parallel to each other.

17. The method of claim 11, wherein forming comprises heating the patchwork blank above an austenization temperature and shaping the patchwork blank.

18. The method of claim 11, wherein the patch is at least partially attached to the main piece by continuous laser welding.

19. The method of claim 11, wherein the first side wall patch portion comprises one or more ribs separated by recesses along a length of the main piece.

20. The method of claim 19, wherein the ribs of the first side wall patch portion are attached to the main piece by continuous laser welding.

21. The method of claim 11, comprising positioning the patch blank and main blank such that the patch of the structural member is positioned in an interior of the main piece.
